(19) United States
(12) Patent Application Publication
(10) Pub. No.: US 2009/0235207 A1
(43) Pub. Date: Sep. 17, 2009

(54) Method and system for managing resources on wireless communication network

(75) Inventor: Eun-seok Choi, Anyang-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Gyeonggi-do (KR)

(21) Appl. No.: 12/289,613

(22) Filed: Oct. 30, 2008

(30) Foreign Application Priority Data
Mar. 11, 2008 (KR) 10-2008-0022535

(51) Int. Cl. G06F 3/048

(52) U.S. Cl. 715/851

(57) ABSTRACT

Provided is a three-dimensional (3D) pointing input apparatus which controls a display apparatus. The 3D pointing input apparatus senses a change according to a movement of the 3D pointing input apparatus upon entering a scroll function mode, and maintains a scrolling speed of a screen of the display apparatus at a threshold speed when a movement range of a virtual scroll cursor of the display apparatus, which moves corresponding to the sensed change, is out of a first area. The 3D pointing input apparatus and method may permit a user to effectively and accurately use a scroll function.

### CROSS-REFERENCE TO RELATED APPLICATIONS

This application claims the benefit under 35 U.S.C. §119(a) of Korean Patent Application No. 10-2008-0022535, filed on Mar. 11, 2008, the disclosure of which is incorporated herein in its entirety by reference.

### BACKGROUND

1. Field

One or more embodiments of the present invention, e.g., as described in the following description, relate to a three-dimensional pointing input apparatus and a method thereof, and more particularly, to a three-dimensional pointing input apparatus that controls a scroll function of a display apparatus and a method thereof.

2. Description of the Related Art

Along with the development of communications and image technologies, display apparatuses such as computer monitors and televisions provide not only images and voice to users, but also allow the users to choose various contents with, for example, interactive televisions. As for the interactive televisions, a general pointing input device, for example, a mouse is required to be located at a particular place, for example, a desk, to control a display apparatus.

Alternatively, remote controllers are provided to control display apparatuses in a three-dimensional space without a limitation in range of motion. However, such the remote controller has direction controllers with limited functions, and thus a user may experience inconvenience, for example, pressing four direction keys several times to select the user's desired function.

To solve such the problem, there is suggested a pointing method which moves a pointer on a display. For example, a gyroscopic pointing apparatus moves a pointer on a screen of a remotely located display apparatus in any directions as a user wishes by holding and moving the pointing apparatus right and left or up and down.

However, the gyroscopic pointing apparatus cannot provide fine control, and especially, accurate control of inputs of a scroll function. Here, the scroll function is selected by, for example, a user's clicking a button on the pointing apparatus, and contents is scrolled automatically on a screen of a display apparatus according to motion of a pointing apparatus. However, since the gyroscopic pointing apparatus is not fixed at a particular position, it is difficult to finely control the cursor due to undesired motion of a user, such as the trembling of hands. Furthermore, a user may move suddenly the gyroscopic pointing apparatus during scrolling an image on a screen, and consequently the screen is scrolled so fast that the user may not be able to read the contents correctly.

### SUMMARY

One or more embodiments of the present invention provide a three-dimensional pointing input apparatus which allows a user to use a scroll function effectively and accurately, and a method thereof.

In particular, one or more embodiments of the present invention provide a three-dimensional pointing input apparatus, which restricts a location of a cursor and a scrolling speed of a screen of a display apparatus upon entering a scroll function mode so that a user can use the scroll function effectively and accurately, and a method thereof.

According to an one or more embodiments of the present invention, there is provided a three-dimensional (3D) pointing input apparatus including a sensor unit which senses a change according to a movement of the 3D pointing input apparatus, and a control unit which maintains a scrolling speed of a screen of the display apparatus at a threshold speed when a movement range of a virtual scroll cursor of the display apparatus, which moves corresponding to the sensed change, is out of a first area.

According to one or more embodiments of the present invention, there is provided an input method of a three-dimensional (3D) pointing input apparatus which controls a display apparatus, the input method including sensing a change according to a movement of the 3D pointing input apparatus upon entering a scroll function mode, and maintaining a scrolling speed of a screen of the display apparatus at a threshold speed when a movement range of the virtual scroll cursor of the display apparatus, which moves according to the sensed change, is out of a first area.

It is to be understood that both the foregoing general description and the following detailed description are exemplary and explanatory and are intended to provide further explanation of the invention as claimed.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a view of an example of a three-dimensional (3D) pointing input apparatus according to an exemplary embodiment of the present invention;

FIG. 2 is a block diagram of a 3D pointing input apparatus according to an exemplary embodiment of the present invention;

FIG. 3 is a flowchart of an input method of a 3D pointing input apparatus according to an exemplary embodiment of the present invention;

FIG. 4 is a flowchart of an input method of a 3D pointing input apparatus according to another exemplary embodiment of the present invention;

FIGS. 5 and 6 are views for explaining in detail an input method of a 3D pointing input apparatus according to an exemplary embodiment of the present invention; and

FIGS. 7 to 9 are views for explaining in detail an input method of a 3D pointing input apparatus according to another exemplary embodiment of the present invention.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

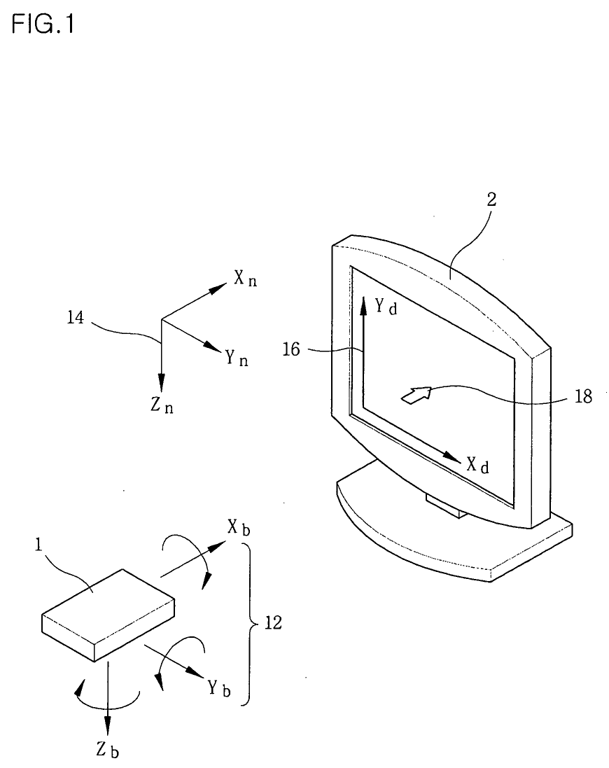

FIG. 1 is a view of an example of a three-dimensional (3D) pointing input apparatus 1 according to an exemplary embodiment of the present invention. Referring to FIG. 1, the 3D pointing input apparatus 1 requires a device coordinate system 12, a virtual coordinate system 14, and a display coordinate system 16 for controlling a display apparatus 2. The display apparatus 2 displays a cursor 18, and the 3D pointing input apparatus 1 is an input device that remotely controls a movement of the cursor 18 in a three-dimensional space. Although the coordinate systems 12, 14, and 16 are specified for the convenience of explanation, the coordinate systems may be combined with each other, for example, the combination of the virtual coordinate system 14 and the display coordinate system 16 may be used, or there may not be the virtual coordinate system 14.

The three-dimensional pointing input apparatus 1 in accordance with the exemplary embodiment of the present invention is useful to control the entry into a scroll function mode. The three-dimensional pointing input apparatus 1 may be used for on-screen-display (OSD) of a television, an electronic program guide (EPG), a multimedia function of a set-top box, and an Internet browser of an Internet protocol television (IPTV) or a graphical user interface (GUI). However, various embodiments other than the above-described functions can be implemented.

The device coordinate system 12 may include Xb-, Yb-, and Zb-axes for representing the motion and posture of the three-dimensional pointing input apparatus 1. Using the three axes, the change according to the motion of a housing of the 3D pointing input apparatus 1, for example, changes in acceleration and angular velocity can be represented. The 3D pointing input apparatus 1 may include an inertial sensor such as an acceleration sensor or an angular velocity sensor. However, the device coordinate system 12 is only an embodiment of the present invention, and any other coordinate system can be employed by the present invention as long as the coordinate system can display the motion and posture of the 3D pointing input apparatus 1. Hereinafter, an additional letter “b” of the coordinates indicates that the corresponding coordinates belong to a pointing device coordinate system.

The virtual coordinate system 14, which is based on the display apparatus 2, is set corresponding to the device coordinate system 12. The additional letter “n” of the coordinates indicates that the corresponding coordinates belong to the virtual coordinate system 14. The 3D pointing input apparatus 1 in accordance with the exemplary embodiment of the present invention can display a location of a scroll cursor of the display apparatus 2 virtually on the virtual coordinate system 14 to correspond to the change represented in the device coordinate system 12 upon entering the scroll function mode.

In the display coordinate system 16, the coordinates of an actual cursor of the display apparatus 2 are shown, and the display coordinate system 16 may include Xd- and Yd-axes. However, the above-described coordinate system is only an example, and any coordinate system is applicable to the present invention as long as it can show coordinates of the cursor of the display apparatus 2. Based on information obtained from the virtual coordinate system 14, the 3D pointing input apparatus 1 in accordance with the exemplary embodiment of the present invention can change the scrolling speed of a screen according to the predetermined division of areas and the coordinates of the display coordinate system 16, corresponding to which the cursor is located on the display apparatus 2.

More specifically, when a user holds the 3D pointing input apparatus 1 and rotates it based on a particular axis of the device coordinate system 12 to enter the scroll function mode, the 3D pointing input apparatus 1 senses the acceleration and the angular velocity according to its movement. Then, the 3D pointing input apparatus 1 computes a location of a virtual cursor of the display apparatus 2 corresponding to the sensed acceleration and angular velocity, for example, the coordinate position of the cursor in the virtual coordinate system 14, and determines if the computed position is within a predetermined area in order to control the scroll cursor and the scrolling speed of the screen of the display apparatus 2.

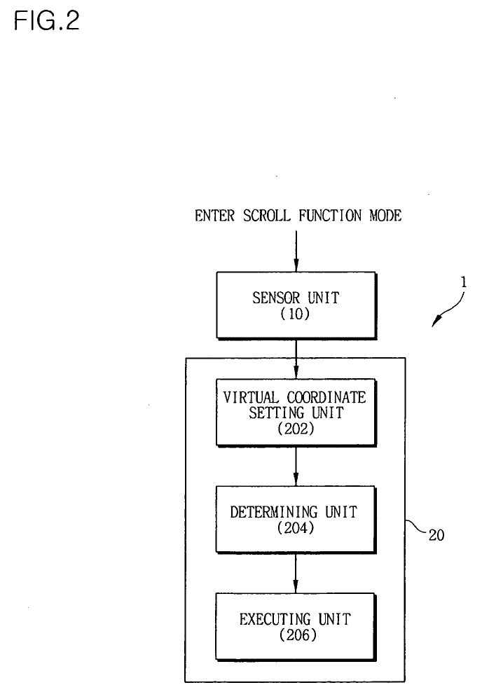

FIG. 2 is a block diagram of a 3D pointing input apparatus 1 according to an exemplary embodiment of the present invention. Referring to FIG. 2, the 3D pointing input apparatus 1 includes a sensor unit 10 and a control unit 20. The control unit 20 includes a virtual coordinate setting unit 202, a determining unit 204, and an executing unit 206.

The sensor unit 10 senses changes according to the movement of the 3D pointing input apparatus 1 upon entering a scroll function mode. The scroll function mode can be launched by a particular operation such as a user's clicking of a scroll button on the 3D pointing input apparatus 1. Then, the sensor unit 10 senses the motion of the 3D pointing input apparatus 1, which includes the acceleration and the angular velocity thereof. For example, when the housing is moved, the rotational angular velocity on each axis, that is, information of rotations on each of the Xb-, Yb-, and Zb-axes of the device cooperate system 12 is sensed. Additionally, the accelerations towards respective Xb-, Yb-, and Zb-axes of the device cooperate system 12 can be sensed.

When the position of the virtual scroll cursor, for example, the position of the cursor on the virtual cooperate system 14 in FIG. 1, which corresponds to the change sensed by the sensor unit 10 upon entering the scroll function mode, is out of a predetermined area of the display apparatus, the control unit 20 controls a screen of the display apparatus 2 to scroll at a threshold speed. Also, the control unit 20 can restrict the movement range of the scroll cursor of the display apparatus 2 within the predetermined area.

If the movement range of a virtual scroll cursor is within the predetermined area, the movement of the screen can be varied according to the sensed change. For example, the screen may be scrolled faster when the virtual scroll cursor has moved further than when the virtual cursor has moved lesser.

More specifically, the virtual coordinate setting unit 202 of the control unit 20 can virtually set a movement range of the scroll cursor of the display apparatus 2 on the virtual coordinate system 14 shown in FIG. 2 to correspond to the change sensed by using the device coordinate system 12 shown in FIG. 1. Here, the virtual coordinate system 14 may be defined by a predetermined area formed as a circle or the like.

The determining unit 204 determines if the position of the virtual scroll cursor represented in the virtual coordinate system 14 shown in FIG. 1 is within or out of the predetermined area, and the executing unit 204 restricts the position of the scroll cursor actually displayed on the display apparatus 2, for example, a location and scrolling speed of the cursor in the display coordinate system 16 in FIG. 1 according to the determination result of the determining unit 204. When the movement range of the virtual scroll cursor demonstrated in the virtual coordinate system 14 in FIG. 1 is not within the predetermined area, the screen is scrolled at a threshold speed, and the movement range of the scroll cursor in the display coordinate system 16 can be restricted within the predetermined area.

Accordingly, the 3D pointing input apparatus 1 in accordance with the exemplary embodiment of the present invention restricts the movement range of the cursor of the display apparatus 2 in the scroll function mode, so that it can be prevented that a scrolling speed of the screen is out of control due to unexpectedly fast movement of the user.

The 3D pointing input apparatus 1 can stop the scroll cursor from scrolling on the screen of the display apparatus 2 by placing the scroll cursor fixedly on the display apparatus 2 for a predetermined period of time upon entering the scroll function mode. This is because it is required to place the scroll cursor at a fixed position for a predetermined period of time for recognizing the start of the scroll function mode. Accordingly, it can be prevented that the scroll function is not selected since the user's hand is trembling or the user moves his/her hand incorrectly while holding the 3D pointing input apparatus 1.

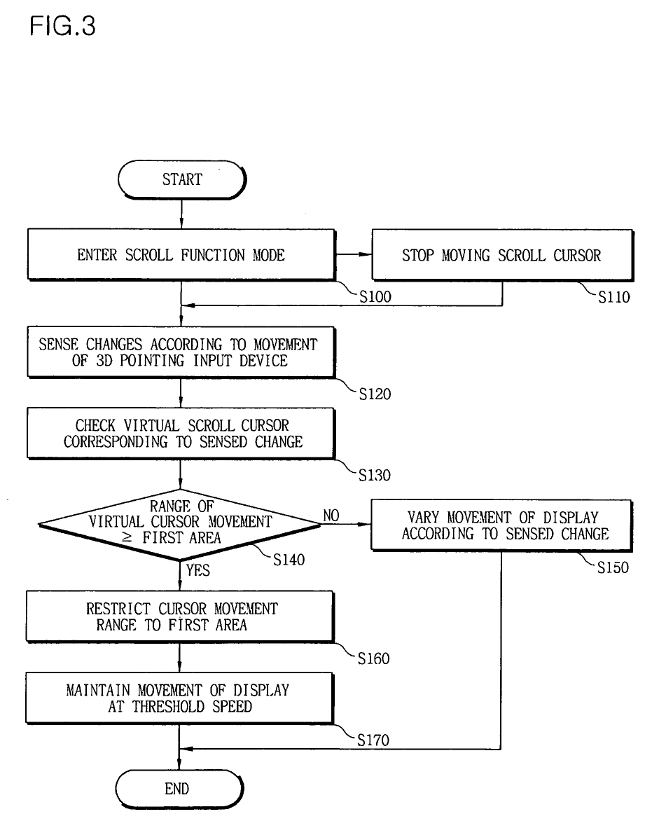

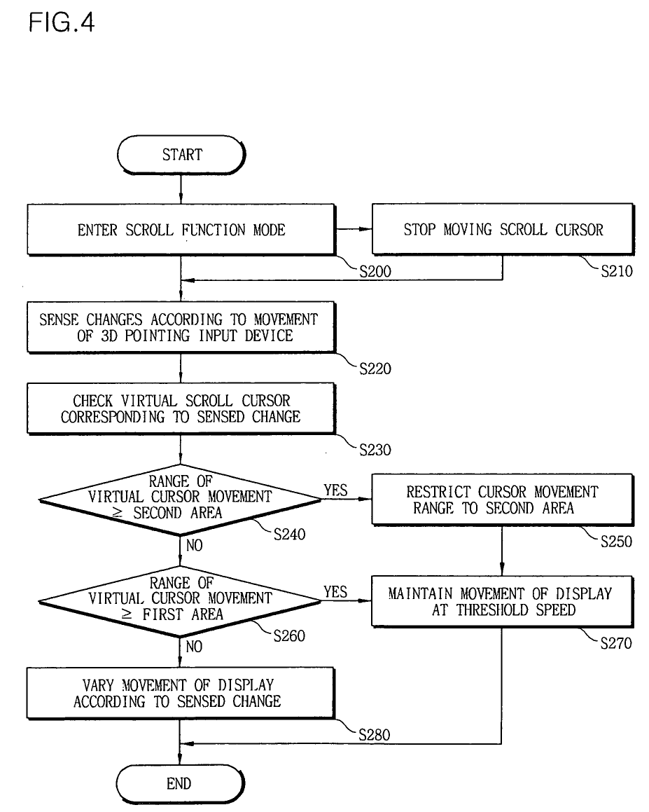

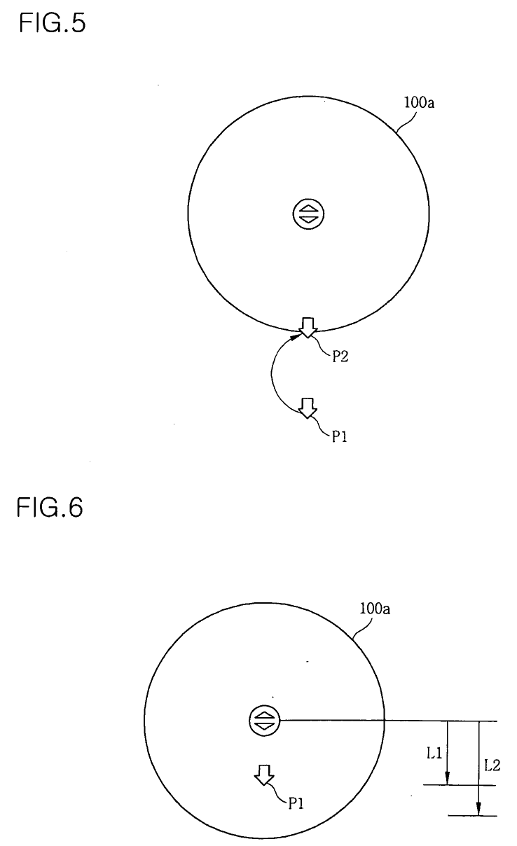

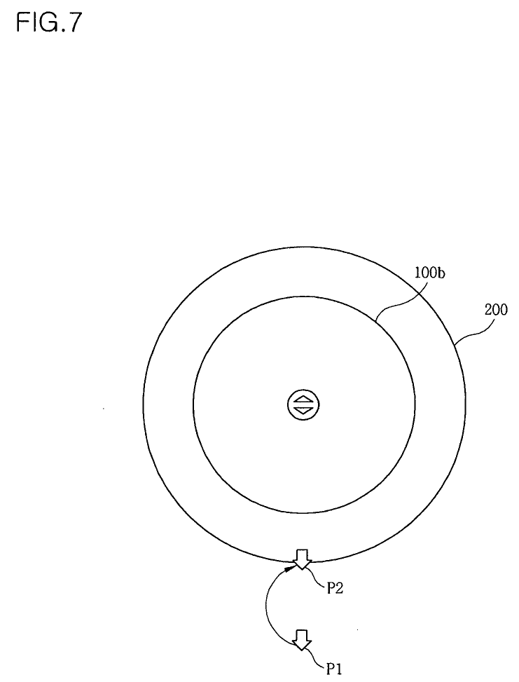

Hereinafter, various input methods for a scroll function of a 3D pointing input apparatus will now be described in detail with reference to FIGS. 3 and 4. FIG. 3 is a flowchart of an input method of a 3D pointing input apparatus when the movement range of a virtual scroll cursor of a display apparatus which corresponds to the movement of the 3D pointing input apparatus is set as a first area 100a which will be described with reference to FIGS. 5 and 6, according to an exemplary embodiment of the present invention. FIG. 4 is a flowchart of an input method of the 3D pointing input apparatus when the movement range of the virtual scroll cursor is set as a first area 100b and a second area 200 which will be described with reference to FIGS. 7 to 9. However, such the flowcharts of the method are only embodiments for facilitating explanation of the present invention, and may include various other embodiments are available.

Referring to FIG. 3, the 3D pointing input apparatus enters a scroll function mode with a user's particular motion, for example, clicking of a scroll button (operation S100). At this time, a scroll cursor can be stopped from scrolling on a screen for a predetermined period of time (operation S110). As the result, it is possible to solve a problem that the user may not be able to use the scroll function when the 3D pointing input apparatus is shaken or moved unexpectedly since the user's hand is trembling without being supported while holding the 3D pointing input apparatus.

The 3D pointing input apparatus senses the changes according to its movement when entering the scroll function mode (operation S120). In this case, the sensed changes may be displayed as coordinates in the device coordinate system 12 in FIG. 1. Subsequently, the location of the virtual scroll cursor of the display apparatus which corresponds to the sensed change is checked (operation S130). To this end, the movement range of the scroll cursor can be displayed in the virtual coordinate system 14 shown in FIG. 1.

Then the 3D pointing input apparatus determines if the movement range of the virtual cursor is within or out of the predetermined range, that is, the first area 100a (in FIG. 5) (operation S140). If it is determined that the movement range is within the first area 100a, a screen is scrolled corresponding to the sensed changes (operation S150). That is, according to the scroll function mode, the moving speed of the cursor on the display apparatus can be varied such that the movement range of the screen of the display apparatus is changed in proportion to the movement range of the 3D pointing input apparatus. At this time, the position of the cursor of the display apparatus is identical with the position of the virtual cursor.

Alternatively, if it is determined that the virtual cursor of the 3D pointing input apparatus is out of the first area 100a (in FIG. 5), the movement range of the cursor on the display apparatus is restricted to the first range 100a (in FIG. 5) (operation S160). Then, the screen is scrolled at a threshold speed (operation S170). Accordingly, even when the motion of the 3D pointing input apparatus is too quick or wide, the screen of the display apparatus is moved at a constant speed, so that the user can easily check the contents on the screen.

Referring to FIG. 4, the 3D pointing input apparatus enters the scroll function mode by a user (operation S200). At this time, to accurately start the scroll function mode, the scroll cursor on the screen of the display apparatus may be stopped for a predetermined period of time (operation S210).

Then, the 3D pointing input apparatus senses changes according to the motion of the 3D pointing input apparatus upon entering the scroll function mode (operation S220). In this case, the movement can be demonstrated on the device coordinate system 12. Then, the location of the virtual scroll cursor of the display apparatus corresponding to the sensed change is checked (operation S230). For example, the location of the scroll cursor of which movement range is demonstrated in the virtual coordinate system 14 in FIG. 1 may be checked.

The 3D pointing input apparatus determines if the movement range of the virtual cursor is within or out of the predetermined range, that is, the second area 200 (in FIG. 7) (operation S240). When it is determined that the virtual cursor is placed out of the second area 200, the movement range of the scroll cursor of the display apparatus is restricted to the second area 200 (in FIG. 7) (operation S250). Then the screen is constantly scrolled at a threshold speed (operation S270).

Alternatively, when it is determined that the movement range of the virtual cursor is within the second area 200 (in FIG. 7), it is determined if the movement range is within or out of the first area 100b (in FIG. 7) which is smaller than the second area 200 and inside the second area 200 (operation S260). When it is determined that the virtual cursor is placed out of the first area 100b (in FIG. 7), the screen of the display apparatus is constantly scrolled at a threshold speed (operation S270). The threshold speed may be the same as when the virtual cursor is placed out of the second area 200 (in FIG. 7). Moreover, the location of the cursor on the screen of the display apparatus is identical with the location of the virtual cursor.

If the movement range of the virtual cursor is within the first area 100b (in FIG. 7), the screen is scrolled according to the sensed change of the 3D pointing input apparatus (operation S280). For example, the movement range of the screen of the display apparatus can be controlled to be in proportion with the movement range of the 3D pointing input apparatus during the scroll function mode. Even in this case, the location of the cursor on the screen of the display apparatus is identical with the location of the virtual cursor.

Various input methods of a 3D pointing input apparatus for using a scroll function will now be described in detail with reference to FIGS. 5 to 9. FIGS. 5 and 6 show the first area 100 by which the region of the virtual coordinate system 14 is defined, and FIGS. 7 to 9 show the first area 100b and the second area 200 by which the region of the virtual coordinate system 14 is defined. The definition of the region of the coordinate system is only for facilitating explanation of descriptions, and may include various embodiments can be implemented.

Referring to FIG. 5, the 3D pointing input apparatus moves a virtual scroll cursor of a display apparatus into a predetermined area to place it corresponding to a cursor on a screen of the display apparatus when the movement range of the virtual scroll cursor is out of a predetermined area, and the virtual scroll cursor moves corresponding to changes in movements of a housing of the 3D pointing input apparatus when the 3D pointing input apparatus enters a scroll function mode. Also, the 3D pointing input apparatus restricts the screen scrolling speed to a threshold speed.

For example, as shown in FIG. 5, when the virtual scroll cursor of the display apparatus moves to P1, which is one of virtual coordinates, corresponding to the movement of the housing, the scroll cursor is out of the predetermined area, the first area 100a, and the actual cursor on the screen of the display apparatus may be moved to P2. Then, the scrolling speed of the screen of the display apparatus can be restricted to a threshold speed.

Referring to FIG. 6, the 3D pointing input apparatus moves the screen and the cursor on the screen of the display apparatus according to the sensed changes of the 3D pointing input apparatus when the virtual scroll cursor of the display apparatus is within the predetermined area, the virtual scroll cursor corresponding to the movement of the housing of the 3D pointing input apparatus when the 3D pointing input apparatus enters the scroll function mode.

For example, as shown in FIG. 6, when the virtual cursor of the display apparatus moves to P1 which is one of virtual coordinates, the virtual scroll cursor is within the predetermined area, the first area 100a, the actual cursor on the screen of the display apparatus can stay at P1. Then, the screen of the display apparatus can be scrolled according to sensed changes in the movement of the 3D pointing input apparatus. For example, when a moving distance of the 3D pointing input apparatus is L1, the screen of the display apparatus can be controlled to scroll slower than when the moving distance of the 3D pointing input apparatus is L2.

Referring to FIG. 7, the 3D pointing input apparatus moves a virtual scroll cursor of a display apparatus into a predetermined area to place it corresponding to a cursor on a screen of the display apparatus when the movement range of the virtual scroll cursor is out of a predetermined area, and the virtual scroll cursor moves corresponding to changes in movements of a housing of the 3D pointing input apparatus when the 3D pointing input apparatus enters a scroll function mode. Also, the 3D pointing input apparatus restricts the screen scrolling speed to a threshold speed.

For example, when the virtual cursor moves to P1 which is one of virtual coordinates according to the movement of the housing, the cursor comes to be out of the second area 200, which is predetermined, and thus the actual cursor on the screen of the display apparatus can be moved to P2. Then, the screen can be controlled to scroll at a threshold speed.

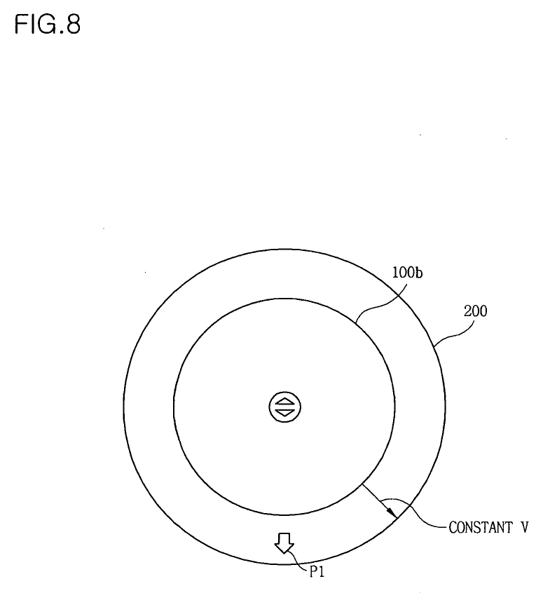

Referring to FIG. 8, the 3D pointing input apparatus places the cursor on the screen of the display apparatus to be at the same location as the virtual scroll cursor of the display apparatus while restricting the scrolling speed of the screen to a threshold speed when the virtual scroll cursor is placed between the predetermined first and second areas 100b and 200 and the virtual scroll cursor moves corresponding to the movement of the housing of the 3D pointing input apparatus when the 3D pointing input apparatus enters the scroll function mode.

For instance, as shown in FIG. 8, when the virtual scroll cursor is placed at P1, which is one of the virtual coordinates, according to the movement of the housing, the actual cursor on the screen of the display apparatus can stay at P1 if the cursor is out of the first area 100b but within the second area 200. Also, the scrolling speed of the screen can be restricted to a threshold speed V.

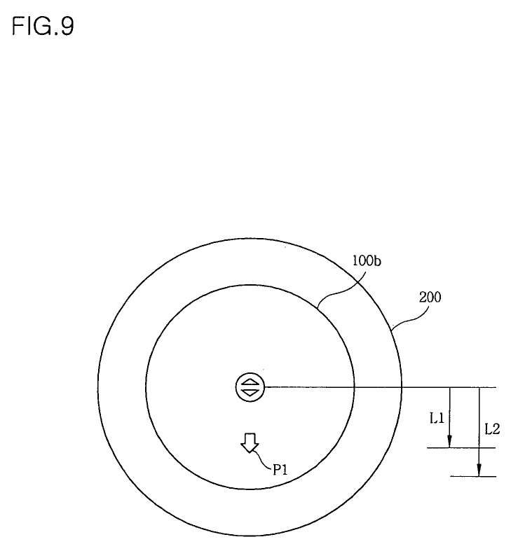

Referring to FIG. 9, the 3D pointing input apparatus moves the screen and the cursor of the display apparatus according to the sensed changes in movements if the virtual scroll cursor of the display apparatus is within both first and second areas 100b and 200, the virtual scroll cursor moving according to the changes in movements of the housing of the 3D pointing input apparatus.

For instance, as shown in FIG. 9, when the virtual scroll cursor is placed at P1 which is within both the first area 100b and the second area 200, the actual cursor on the screen of the display apparatus can stay at P1. The screen can be scrolled according to the sensed change of the 3D pointing input apparatus. As the result, if the moving distance of the 3D pointing input apparatus is L1, the screen of the display apparatus can be controlled to scroll slower than when the moving distance of the 3D pointing input apparatus is L2.

In brief, the 3D pointing input apparatus in accordance with the exemplary embodiment of the present invention enables a user to use an accurate scroll function by restricting the location and the scrolling speed of the scroll cursor when the motion of user's hand is not accurate enough for entering the scroll function mode, for example, the user moves his/her hand too fast.

Furthermore, when a 3D pointing input apparatus enters a scroll function mode, a scroll cursor of a display apparatus needs to be fixed at a particular position on a screen. The 3D pointing input apparatus in accordance with the exemplary embodiment of the present invention stops the scroll cursor from moving on the screen of the display apparatus for a predetermined period of time, so that the 3D pointing input apparatus can easily enter the scroll function mode even when the user trembles his/her hand or moves the hand improperly without being supported.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A three-dimensional (3D) pointing input apparatus which controls a display apparatus, the 3D pointing input apparatus comprising:
a sensor unit which senses a change according to a movement of the 3D pointing input apparatus; and
a control unit which maintains a scrolling speed of a screen of the display apparatus at a threshold speed when a movement range of a virtual scroll cursor of the display apparatus, which moves corresponding to the sensed change, is out of a first area.

2. The 3D pointing input apparatus of claim 1, wherein the control unit restricts a movement range of a scroll cursor on the screen to be within the first area when the virtual scroll cursor is placed out of the first area.

3. The 3D pointing input apparatus of claim 1, wherein the control unit controls a scrolling speed of the screen according to the sensed change of the 3D pointing input apparatus when the virtual scroll cursor is placed within the first area.

4. The 3D pointing input apparatus of claim 1, wherein the control unit stops the scroll cursor from moving for a predetermined period of time upon entering a scroll function mode.

5. The 3D pointing input apparatus of claim 1, wherein the control unit restricts a movement range of a scroll cursor on the screen to be within a second area when the virtual scroll cursor is placed out of the first area.

6. An input method of a three-dimensional (3D) pointing input apparatus which controls a display apparatus, the input method comprising:
sensing a change according to a movement of the 3D pointing input apparatus upon entering a scroll function mode; and
maintaining a scrolling speed of a screen of the display apparatus at a threshold speed when a movement range of the virtual scroll cursor of the display apparatus, which moves according to the sensed change, is out of a first area.

7. The input method of claim 6, wherein in the maintaining of the scrolling speed of the screen, a movement range of a scroll cursor on the screen is restricted to be within the first area when the virtual scroll cursor is placed out of the first area.

8. The input method of claim 6, further comprising:
varying the movement of a scroll cursor on the screen according the sensed change of the 3D pointing input apparatus when the movement range of the virtual scroll cursor is within the first area.

9. The input method of claim 6, further comprising:
stopping movement of a scroll cursor on the screen for a predetermined period of time upon entering the scroll function mode.
